(19) United States
(12) Patent Application Publication
(10) Pub. No.: US 2025/0377891 A1
(43) Pub. Date: Dec. 11, 2025

(54) METHODS AND APPARATUS FOR BRANCH INSTRUCTION SECURITY

(71) Applicant: Arm Limited, Cambridge (GB)

(72) Inventor: Dániel Kristóf Kiss, Budapest (HU)

(73) Assignee: Arm Limited, Cambridge (GB)

(21) Appl. No.: 18/877,052

(22) PCT Filed: May 25, 2023
(86) PCT No.: PCT/GB2023/051365

§ 371 Date: Dec. 19, 2024

(30) Foreign Application Priority Data
Jun. 28, 2022 (GB) 2209446.0

(51) Int. Cl. G06F 9/30; G06F 9/32; G06F 21/60

(52) U.S. Cl. CPC G06F 9/30058; G06F 9/323; G06F 21/602

(57) ABSTRACT

Aspects of the present disclosure relate to an apparatus. Instruction receiving circuitry receives, as part of a program flow, a branch instruction, said branch instruction identifying a function. Instruction authentication circuitry determines, based at least in part on the function, an instruction authentication value. The instruction authentication circuitry then combines the instruction authentication value with the branch instruction to produce an authenticatable branch instruction. Branch circuitry authenticates the authenticatable branch instruction based on a function authentication value. Responsive to a successful authentication of the authenticatable branch instruction, the branch circuitry executes a jump in the program flow to said function.

### BACKGROUND

The present technique relates to the field of authentication of pointers and branch instructions.

In some processing systems, pointers are vulnerable to malicious attacks. For example, a pointer could be maliciously modified in order to modify the functioning of a program, for example to redirect program flow in an unintended manner.

Similarly, branch instructions, which cause a program flow to jump to a different point in a series of instructions, could be maliciously modified to redirect program flow.

Methods exist for mitigating such malicious attacks. For example, a pointer could be cryptographically signed, and the signature used to verify the pointer. Similarly, the security of branch instructions can be improved by providing a way to validate the branch instructions.

However, such mitigations may not provide total security, and thus there may still be a risk of malicious attack. There is thus a desire for methods to improve the security of pointers and branch instructions.

### SUMMARY

At least some examples provide an apparatus comprising:
instruction receiving circuitry to receive, as part of a program flow, a branch instruction, said branch instruction identifying a function;
instruction authentication circuitry to:
   determine, based at least in part on the function, an instruction authentication value; and
   combine the instruction authentication value with the branch instruction to produce an authenticatable branch instruction, and branch circuitry to:
   based on a function authentication value, authenticate the authenticatable branch instruction; and
   responsive to a successful authentication of the authenticatable branch instruction, execute a jump in the program flow to said function.

Further examples provide a method comprising:
receiving, as part of a program flow, a branch instruction, said branch instruction identifying a function;
determining, based at least in part on the function, an instruction authentication value;
combining the instruction authentication value with the branch instruction to produce an authenticatable branch instruction;
based on a function authentication value, authenticating the authenticatable branch instruction; and
responsive to a successful authentication of the authenticatable branch instruction, executing a jump in the program flow to said function.

Further examples provide non-transitory computer-readable medium to store computer-readable code for fabrication of the above-mentioned apparatus.

Further examples provide a computer program for controlling a host data processing apparatus to provide an instruction execution environment comprising:
instruction receiving logic to receive, as part of a program flow, a branch instruction, said branch instruction identifying a function;
instruction authentication logic to:
   determine, based at least in part on the function, an instruction authentication value; and
   combine the instruction authentication value with the branch instruction to produce an authenticatable branch instruction, and branch logic to:
   based on a function authentication value, authenticate the authenticatable branch instruction; and
responsive to a successful authentication of the authenticatable branch instruction, execute a jump in the program flow to said function.

Further aspects, features and advantages of the present technique will be apparent from the following description of examples, which is to be read in conjunction with the accompanying drawings.

### BRIEF DESCRIPTION OF THE DRAWINGS

FIGS. 1A to 1C schematically apparatuses according to examples.

FIGS. 2A to 2C depict pointer authentication in a comparative example.

FIGS. 3A to 3C depicts pointer authentication according to an example.

FIGS. 4A and 4B depict branch instruction authentication, according to an example.

FIGS. 5A and 5B depict generation and authentication of a signed encrypted pointer, according to an example.

FIGS. 6 and 7 depict example methods.

FIG. 8 depicts a computer-readable medium according to an example.

FIG. 9 depicts an example simulator implementation.

### DESCRIPTION OF EXAMPLES

In an example of the present disclosure, an apparatus has interface circuitry and pointer processing circuitry. These may be dedicated circuitry components, or logical units implemented by general-purpose circuitry such as a central processing unit or other processor. For example, the presently described apparatus may be implemented by a component of a processor which is responsible for processing pointers.

The interface circuitry is configured to receive a pointer. The pointer comprises a plurality of address bits, which identify a memory location to which the pointer points. For example, the pointer may be generated as part of the execution of a series of processing instructions.

The pointer processing circuitry is configured to extract the plurality of address bits from the pointer. The pointer processing circuitry then encrypts the plurality of address bits, to produce a plurality of encrypted address bits.

The pointer processing circuitry is further configured to determine, based at least in part on the plurality of address bits, a pointer authentication value. This may for example be based on a hash and/or an encryption of the plurality of address bits.

The pointer processing circuitry then combines the pointer authentication value with the plurality of encrypted address bits, to produce a signed encrypted pointer. In effect, the pointer authentication value serves as a signature for the pointer, which can be used to authenticate the pointer. For example, if the address bits are maliciously modified, the pointer authentication value would no longer match the address bits.

The encryption of the address bits serves to improve security. In particular, in some comparative examples which do not implement the present disclosure, the address bits could be modified and a corresponding pointer signature value could be guessed. This is a particular risk in systems in which relatively few bits are available for the signature, for example where a given size is available to store a pointer, and the signature is stored in spare bits which are not used for the address.

In the present example, in contrast, the encryption of the address bits significantly reduces the risk of an attacker modifying the address bits and correctly guessing a corresponding authentication value. System security is thereby improved. This is particularly effective in systems in which the pointer address bits are not expected to change once they have been set. This method is also particularly effective in systems in which it is not architecturally required for the address part of a signed pointer to be the actual address: in such situations, the signed encrypted pointer can be stored in the same manner as an unencrypted signed pointer.

In an example, the pointer processing circuitry performs a cryptographic shuffle on the combined pointer authentication value and encrypted address bits. This further improves security, because a malicious attacker would not be able to determine which bits (and in which order) correspond to the address, and which correspond to the pointer authentication value. This can be particularly efficiently performed by performing the shuffle based on the same cryptographic key that is used to encrypt the plurality of address bits. This may be a pointer authentication code (PAC) key which is kept secret by the apparatus and stored in a software-inaccessible storage, such as a system register. Key security may be improved by restricting access to the key to processes having a high privilege level. In addition to the key, a cryptographic modifier may be applied, to increase the diversity of the key.

As described above, the actual address bits are obscured by way of encryption. In some examples, the pointer processing circuitry is further configured to obscure the pointer authentication value, thereby further improving security. This may for example be performed by way of at least one of a hash, and an encryption, of the pointer authentication value. Such an encryption may be efficiently performed using the same encryption key that is used to encrypt the address bits.

The above description sets out various ways in which a signed encrypted pointer can be produced. Various ways will now be described for decrypting and authenticating such a signed encrypted pointer, for example as part of a later processing instruction which requires the address to which the pointer is directed.

In examples, the apparatus comprises pointer decryption circuitry which is configured to extract the pointer authentication value and, based on the extracted pointer authentication value, authenticate the signed encrypted pointer. In some examples in which a cryptographic shuffle was performed on the combined authentication value and pointer, the extraction may include performing a cryptographic deshuffle of the signed encrypted pointer and extracting a block of bits, corresponding to the pointer authentication value, from the deshuffled signed encrypted pointer.

In order to authenticate the signed encrypted pointer, the pointer decryption circuitry confirms that the pointer authentication value correctly matches the address bits. For example, the pointer decryption circuitry may extract the plurality of encrypted address bits and decrypt them. It may then repeat the above-described process which was used to initially determine the pointer authentication value, to determine a re-calculated pointer authentication value. It can then be verified whether the extracted (and decrypted) pointer authentication value matches the re-calculated pointer authentication value. If they match, it can be determined that the signed encrypted pointer was authentic, and the extracted address bits are safe to use for further processing. For example, the pointer decryption circuitry may be responsive to a successful authentication of the signed encrypted pointer to execute a processing instruction based on the address bits of said pointer.

Conversely, the pointer decryption circuitry is responsive to a failed authentication of the signed encrypted pointer to identify an error. For example, this may mean that the pointer has been maliciously altered, and should be discarded.

In the above description, the address bits of the pointer are encrypted prior to being combined with the pointer authentication value. However, in other examples, the unencrypted address bits are combined with the pointer authentication value, and then the combination is encrypted. In such an example, the pointer processing circuitry is configured to extract the plurality of address bits from the pointer and to determine, based at least in part on the address bits, a pointer authentication value. The pointer processing circuitry then combines the pointer authentication value with the plurality of address bits, and encrypts the combination to produce a signed encrypted pointer. This has the end result, similar to the previous examples, of producing a signed encrypted pointer which is resilient to malicious attack. In some systems (e.g. depending on the particular configuration of a given apparatus), the present example may be particularly computationally efficient.

The above description relates to pointer security. However, an analogous process can be applied to improve the security of branch instructions. Examples of such processes will now be described. These can optionally be performed in combination with the above-described pointer security processes: this synergistically improves security relative to applying one or the other alone, and improved efficiency (in particular where the same circuitry or logical components can be used for both).

In one such example, an apparatus comprises instruction receiving circuitry to receive, as part of a program flow, a branch instruction. The branch instruction directs the program flow to jump to another location within a series of processing instructions. In this example, the branch instruction identifies a function, for example by identifying a branch target (or “landing pad”) which is a first instruction in that function.

The apparatus further comprises instruction authentication circuitry configured to determine, based at least in part on the function, an instruction authentication value. Similarly to the above-described pointer authentication value, the instruction authentication value may be based on data indicative of at least part of the code corresponding to said function. For examples, this may be a hash or digest of the code.

The instruction authentication circuitry is configured to combine the instruction authentication value with the branch instruction, to produce an authenticatable branch instruction.

Specifically, the branch instruction is authenticatable with reference to the instruction authentication value.

The apparatus further comprises branch circuitry configured to, based on a function authentication value, authenticate the authenticatable branch instruction. This may for example be performed prior to executing the branch instruction, to confirm that the branch instruction has not been tampered with. The instruction may be authenticated by comparing the instruction authentication value with the function authentication value. For example, the function authentication value may be a known value which would be equal to a correct instruction authentication value. In this example, the branch circuitry may be configured to determine a successful authentication of the authenticatable branch instruction responsive to the instruction authentication value matching the function authentication value. This provides an effective way to authenticate a branch instruction.

Responsive to a successful authentication of the authenticatable branch instruction, the branch circuitry executes a jump in the program flow to the aforementioned function.

In this manner, the present apparatus provides additional security for branch instructions, relative to comparative examples in which branch instructions are not authenticatable. In such comparative examples, a branch instruction could be tampered with, for example to cause a jump to malicious code. In the present example, such tampering would cause the branch instruction to longer correspond to the instruction authentication value, which would be detected as a failed authentication of the authenticatable branch instruction.

In some examples, the function authentication value may be stored within code corresponding to said function. In particular, this may be stored immediately subsequent to a branch target indicator (or “landing pad”) in the code corresponding to said function. A branch target indicator is a type of instruction which serves to provide a potential target for a branch target instruction. In such examples, it may be enforced that branch instructions cannot define branches to arbitrary code locations, but instead can only validly target a branch target instruction. This improves security, but comparative examples which implement branch target instructions, but do not use the presently described techniques, can still have security vulnerabilities. For example, a malicious attacker could modify a branch instruction to identify a branch target instruction in an incorrect function. The present technique significantly improves security relative to such comparative examples, because it provides assurance that the branch target instruction still identifies the correct function which it was initially targeted at: the instruction authentication value is compared with the function authentication value which immediately follows the branch target instruction at which the branch instruction is directed.

As described above, the branch circuitry responds to a successful authentication by executing the branch instruction. Conversely, the branch circuitry may be responsive to an unsuccessful authentication of the authenticatable branch instruction to identify an error. The error may be addressed by declining to follow the branch instruction, and/or reporting an error and ceasing execution of the flow of processing instructions.

In an example, the aforementioned combining of the branch instruction with the instruction authentication value comprises performing a cryptographic shuffle on the branch instruction and instruction authentication value. This obscures the identity of the bits which correspond to the instruction and the bits which correspond to the authentication value, thereby increasing the difficulty of successfully tampering with the authenticatable instruction. In particular, this makes it significantly more difficult to tamper with the instruction in such a way that it would still pass the authentication process.

Alternatively or additionally, the instruction authentication circuitry may be configured to encrypt the branch instruction, or the combination of the branch instruction and authentication value, with a cryptographic key. This improves security by reducing the possibility that the branch instruction can be tampered with in such a way that it would pass the authentication process. The encryption and the aforementioned cryptographic shuffle may efficiently be performed using the same cryptographic key.

In an example, the branch circuitry is configured to extract the instruction authentication value from the authenticatable instruction, and perform the authentication of the authenticatable branch instruction based on the extracted function authentication value. This provides an effective way of authenticating the instruction. This may be performed by way of a cryptographic deshuffle (i.e. the inverse of the aforementioned shuffle) of the authenticatable branch instruction, after which a block of bits corresponding to the instruction authentication value can be extracted from the dedhuffled authenticatable branch instruction.

Similarly, the branch circuitry may be configured to identify an address associated with the function (i.e. a target address of the branch instruction) by extracting a plurality of address bits from the authenticatable branch instruction. The branch circuitry then executes the jump based on the plurality of address bits. This provides an effective way of executing the underlying branch instruction.

Examples of the present disclosure will now be described with reference to the drawings.

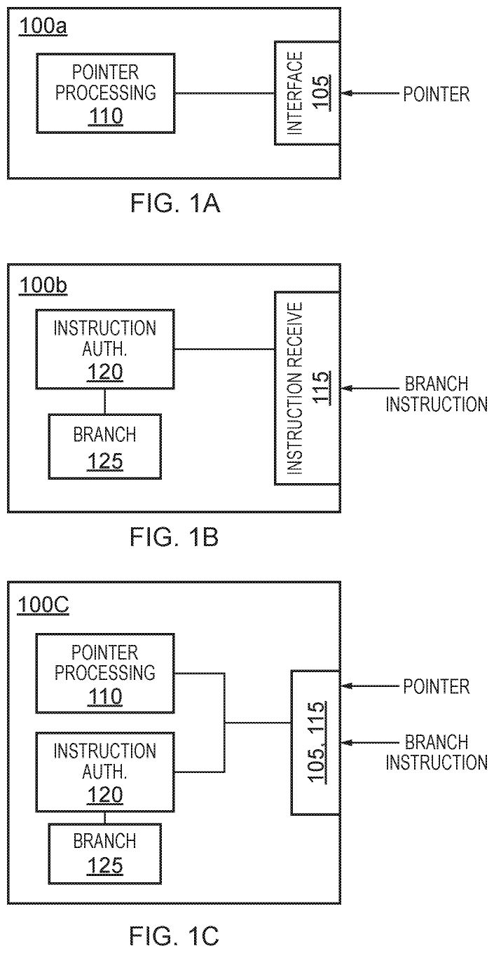

FIGS. 1A to 1C schematically show apparatuses 100a, 100b, 100c according to examples of the present disclosure. The apparatuses may be implemented with dedicated circuitry components, for example elements of a processing apparatus such as a central processing unit (CPU). Alternatively, one or more of the components of the apparatuses may be implemented as logical, functional units executed by general-purpose processing circuitry.

FIG. 1A shows an apparatus 100a which is configured to implement the above-described methods for improving pointer security.

The apparatus 100a comprises interface 105 which is configured to receive a pointer having an address (to which the pointer points).

The apparatus 100a further comprises pointer processing circuitry 110 which is configured to process the pointer. Specifically, the pointer processing circuitry extracts and encrypts the address from the pointer. It also determines, based on the address, a pointer authentication code (PAC). Finally, it combines the encrypted address with the PAC, to produce a signed encrypted pointer. This pointer may then be stored in a storage element, such as a register, cache or memory, for subsequent usage.

FIG. 1B shows an apparatus 100b which is configured to implement the above-described methods for improving branch instruction security.

The apparatus 100b comprises instruction receiving circuitry 115 which is configured to receive, as part of a program flow, a branch instruction which identifies a function (e.g. by way of an address corresponding to a first instruction within the function).

The apparatus 100b further comprises instruction authentication circuitry 120, which is configured to determine an instruction authentication value based on the function. Branch circuitry 125 then combines the instruction authentication value with the branch instruction to produce an authenticatable branch instruction. The authenticatable branch instruction may be stored in a storage element, such as one of the aforementioned registers, or a cache or memory, for subsequent execution.

The apparatus 100c additionally comprises branch circuitry 125, which is configured to authenticate the authenticatable branch instruction (e.g. whilst stored in a register) based on a function authentication value. Responsive to a successful authentication, the branch circuitry 125 executes a jump in the program flow to said function.

FIG. 1C depicts an apparatus 100c which is configured to perform the functionality of both apparatuses 100a, 100b. It thus comprises a shared interface 105, 115 which is configured to receive pointers and branch instructions. This may alternatively be implemented by way of separate interfaces. The apparatus 100c further comprises pointer processing circuitry 110, instruction authentication circuitry 120 and branch circuitry 125, as described above. The apparatus 100c thus provides improved security for pointers and for branch instructions. This is particularly synergistic if the elements 110, 120, 125 can share components (i.e. if, despite being depicted separately, the same circuitry is used for determining and authenticating pointers and branch instructions).

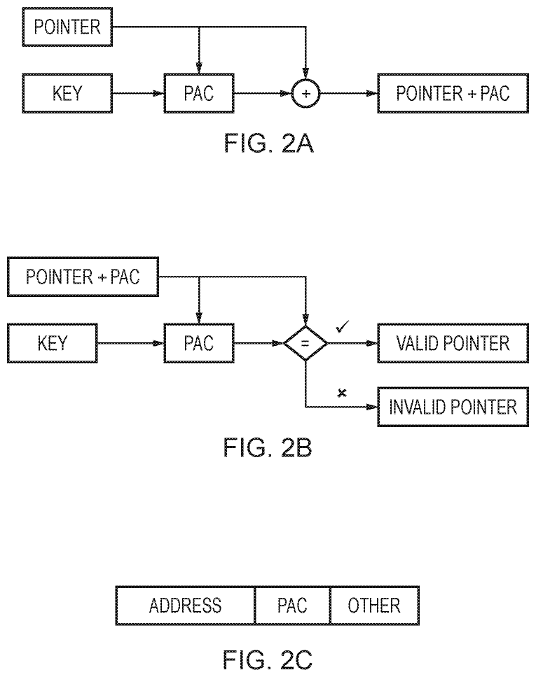

FIGS. 2A to 2C depict pointer authentication in a comparative example which does not implement aspects of the present disclosure.

FIG. 2A shows the production of a signed pointer. The address bits of a (not-yet-signed) pointer is cryptographically combined with a PAC key to produce a PAC. The PAC is then combined with the pointer, to produce a combined pointer and PAC, which functions as a signed pointer.

FIG. 2B shows an authentication of the signed pointer of FIG. 2A. The signed pointer is cryptographically combined with the PAC key to re-produce the PAC. For example, address bits may be extracted, and a new PAC re-calculated in the same way as FIG. 2A. It is then confirmed whether the re-calculated PAC matches the PAC of the signed pointer. If it matches, the pointer is deemed valid. Otherwise, the pointer is deemed invalid.

FIG. 2C shows one possible configuration of the signed pointer, in which the PAC is appended to the address bits. In some examples, other information is also comprised within the signed pointer, for example tag bits or other metadata.

The present method provides a measure of security: if the address is modified (e.g. to redirect program flow to malicious code), the re-produced PAC will not match the original PAC. However, in some examples, not many bits are available to store the PAC (for example, the PAC may be stored in “leftover” bits in the pointer which are not used to store the address or other information). A correct PAC may thus be guessable, leading to a maliciously altered pointer that would appear authentic.

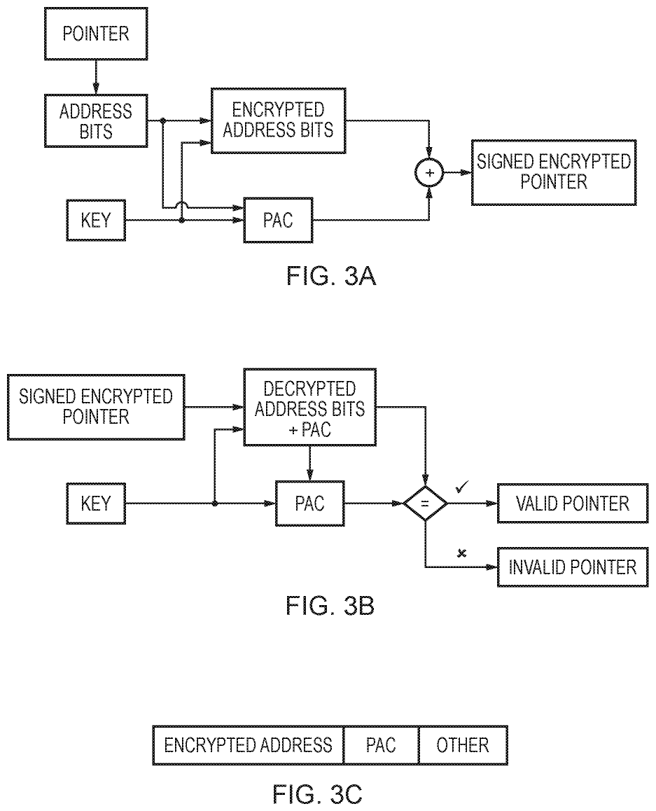

FIGS. 3A to 3C depict improved pointer authentication, according to an example. This may for example be performed by the apparatuses 100a, 100c of FIGS. 1A and 1C.

FIG. 3A shows production of a signed encrypted pointer. Address bits are extracted from a (not-yet-signed) pointer, and encrypted based on a cryptographic key (which may be the aforementioned PAC key). The address bits are also used to generate a PAC, in the same way as for FIG. 2A. The encrypted address is then combined with the PAC to produce a signed encrypted pointer.

FIG. 3B shows authentication of the signed encrypted pointer of FIG. 3A. The address part of the signed encrypted pointer is decrypted, to produce decrypted address bits. The PAC is also extracted. The decrypted address is then cryptographically combined with the key, to re-calculate a PAC in the same way as FIG. 2B. This re-calculated PAC is compared with the PAC that was extracted from the signed encrypted pointer. As for FIG. 2B, if they match, the decrypted pointer is deemed valid. If they do not match, the decrypted pointer is deemed invalid.

FIG. 3C depicts a possible configuration of the signed encrypted pointer, in which the PAC is appended to the encrypted address. As in FIG. 3C, the pointer may also include other information.

The present example thus also allows detection of pointer modification, based on a PAC. However, security is significantly improved by the encryption of the address: it is significantly more difficult to modify the pointer in such a way that it (seemingly validly) points to malicious code. The inventors have realised that this is particularly effective in architectures in which the “address” of a pointer does not actually have to be the actual address, and can be replaced by an encrypted address.

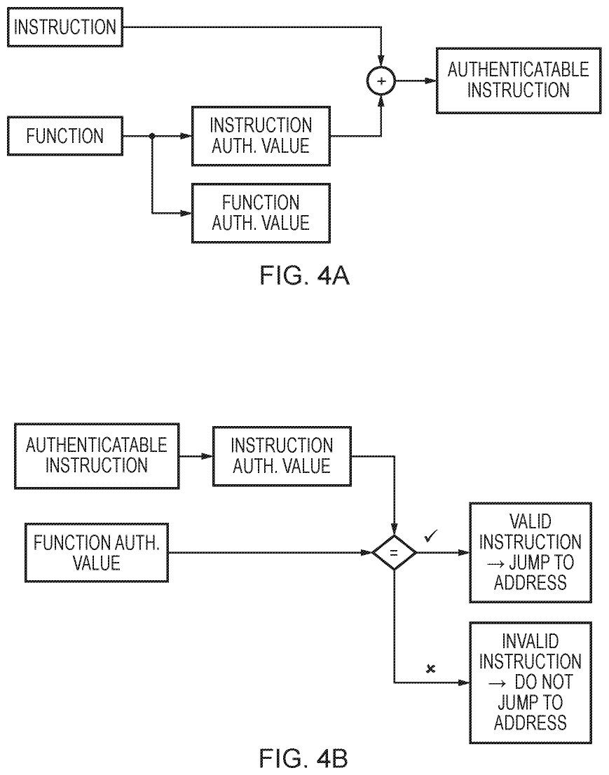

FIGS. 4A and 4B depict branch instruction authentication, according to an example. This may for example be performed by the apparatuses 100b, 100c of FIGS. 1B and 1C.

FIG. 4A shows the production of an authenticatable branch instruction. One skilled in the art will appreciate that this is analogous to the process shown in FIG. 3A. A function, to which an instruction could point, is processed to determine a function authentication value. This may for example be a hash of the function. This is then stored within the instruction. For example, it may immediately follow a branch target instruction.

A (not-yet-authenticatable) branch instruction is received, which corresponds to a branch to the aforementioned function. An instruction authentication value is determined, based on the function. This may for example be the same as the function authentication value. The instruction authentication value is combined with the branch instruction, to produce an authenticatable branch instruction. This may for example be stored in a register, or other storage, for subsequent execution.

FIG. 4B shows the authentication of an authenticatable branch instruction. This may for example be performed prior to, or as part of, executing the branch instruction. One skilled in the art will appreciate that this is analogous to the process shown in FIG. 3A. The aforementioned authenticatable branch instruction is processed to extract the instruction authentication value. The function authentication value is retrieved from the function, and compared with the instruction authentication value. If they match, the branch instruction is deemed authentic, and a jump to the address identified in the instruction can be safely performed. Conversely, if they do not match, the instruction may have been maliciously modified and thus the jump is not performed.

Significantly improved branch instruction security is thus provided. This can be further improved by encrypting at least part of the branch instruction in the manner described above in relation to FIGS. 3A and 3B.

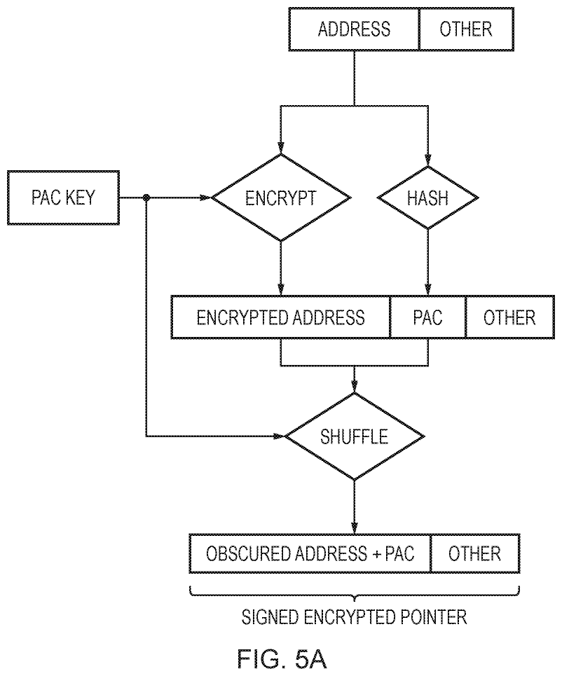

A more detailed method for providing further pointer security will now be described with reference to FIGS. 5A and 5B. One skilled in the art will appreciate that the same method can be applied to the present techniques for improving branch instruction security.

FIG. 5A shows a method for producing a signed encrypted pointer.

Initially, a (not-yet-signed-and-encrypted) pointer comprises an address and, optionally, some other information. The address is extracted and encrypted, based on a PAC key, to produce an encrypted address. The address is also hashed, to produce a PAC of an appropriate size (e.g. a size that would fit in “unused” bits of the pointer, in systems in which a pointer has a given size defined by the architecture). The encrypted address and PAC are combined, leading to a similar pointer to that produced in FIG. 3A.

The encrypted address and PAC are then cryptographically shuffled, based on the PAC key, to produce an obscured address-PAC combination. This improved security, because a malicious actor will not be able to determine which bits correspond to the address and which to the PAC.

The obscured address-PAC combination (and optionally the aforementioned other information) is then output, as a signed encrypted pointer.

FIG. 5B depicts a method for decrypting and authenticating the encrypted signed pointer of FIG. 5A.

The obscured address-PAC combination is extracted from the encrypted signed pointer and, based on the PAC key, cryptographically deshuffled. This serves to separate the encrypted address and the PAC.

The encrypted address is decrypted based on the PAC, to recover the address. The recovered address is then hashed in the same way as the hash of FIG. 5A, and it is confirmed whether this is equal to the deshuffled PAC. If so, the pointer is deemed authentic and safe to use. However, if the hash does not match the deshuffled PAC, it is determined that the pointer is invalid and an error is reported. This is effective because any modification of the obscured address-PAC combo would lead to an “address” and “PAC” which do not correctly correspond.

Provided the hash check is successful, the address is then used as the address of a decrypted authenticated pointer.

The above method thus provides significantly improved security of pointer authentication. For brevity, these figures are not repeated for the case of branch instruction security. However, one skilled in the art will appreciate that the same method can be applied to produce (and authenticate) securely authenticatable branch instructions.

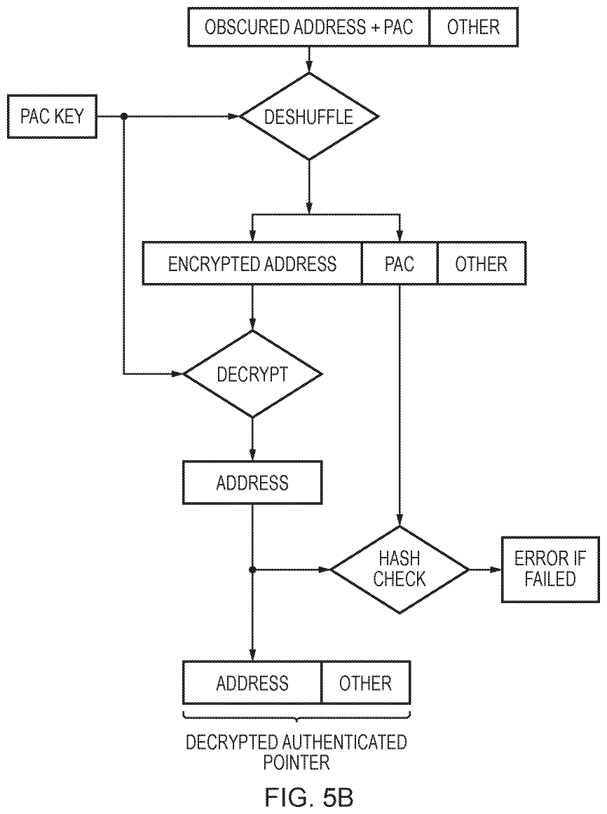

FIG. 6 depicts a method according to an example.

Initially, a pointer is received (605).

Address bits are extracted (610) from the pointer.

The address bits are encrypted (615).

A PAC is determined (620).

The PAC is combined (625) with the encrypted address bits to produce a signed encrypted pointer.

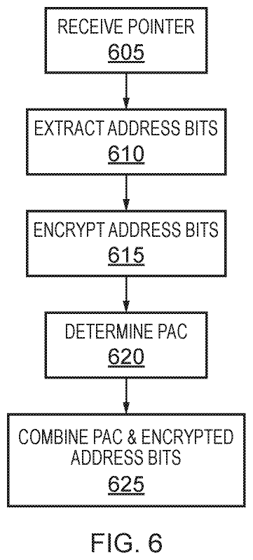

FIG. 7 depicts a method according to an example.

A branch instruction is received (705).

An instruction authentication value is determined (710).

The instruction authentication value is combined (715) with the instruction, to produce an authenticatable branch instruction.

The authenticatable branch instruction is authenticated (720) based on a function authentication value.

Responsive to a successful authentication, ajump is executed (725) to an address defined in the instruction.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts.

The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL.

Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII.

The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

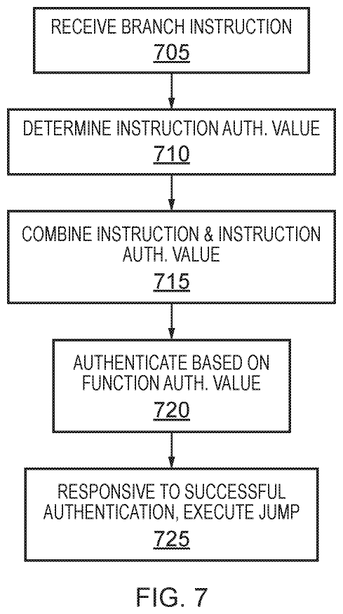

FIG. 8 shows an example of such a computer-readable medium 805, which comprises code 810 for fabrication of one or more of the apparatuses described herein.

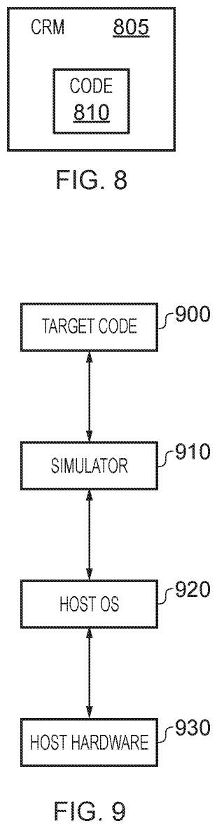

FIG. 9 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on host hardware such as a host processor 930, optionally running a host operating system 920, supporting the simulator program 910. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 930), some simulated embodiments may make use of the host hardware, where suitable.

The simulator program 910 may be stored on a computer-readable storage medium (which may be a non-transitory medium), and provides a program interface (instruction execution environment) to the target code 900 (which may include applications, operating systems and a hypervisor) which is the same as the interface of the hardware architecture being modelled by the simulator program 910. Thus, the program instructions of the target code 900 may be executed from within the instruction execution environment using the simulator program 910, so that a host computer 930 which does not actually have the hardware features of the apparatuses discussed above can emulate these features.

Apparatuses and methods are thus provided for improving security of pointers and branch instructions From the above description it will be seen that the techniques described herein provides a number of significant benefits. In particular, the risk of undetected malicious modification of pointers and branch instructions is significantly reduced.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
instruction receiving circuitry to receive, as part of a program flow, a branch instruction, said branch instruction identifying a function;
instruction authentication circuitry to:
determine, based at least in part on the function, an instruction authentication value; and
combine the instruction authentication value with the branch instruction to produce an authenticatable branch instruction, and branch circuitry to:
based on a function authentication value, authenticate the authenticatable branch instruction; and
responsive to a successful authentication of the authenticatable branch instruction, execute a jump in the program flow to said function.

2. An apparatus according to claim 1, wherein the function authentication value is stored within code corresponding to said function.

3. An apparatus according to claim 2, wherein the function authentication value is stored immediately subsequent to a branch target indicator in the code corresponding to said function.

4. An apparatus according to claim 1, wherein the instruction authentication circuitry is configured to determine the instruction authentication value based on data indicative of at least part of code corresponding to said function.

5. An apparatus according to claim 1, wherein the branch circuitry is configured to authenticate the authenticatable branch instruction by comparing the instruction authentication value with the function authentication value.

6. An apparatus according to claim 5, wherein the branch circuitry is configured to determine a successful authentication of the authenticatable branch instruction responsive to the instruction authentication value matching the function authentication value.

7. An apparatus according to claim 5, wherein the branch circuitry is responsive to an unsuccessful authentication of the authenticatable branch instruction to identify an error.

8. An apparatus according to claim 1, wherein the instruction authentication circuitry is configured to encrypt the branch instruction based on a cryptographic key.

9. An apparatus according to claim 1, wherein said combining, performed by the instruction authentication circuitry, comprises performing a cryptographic shuffle on the instruction authentication value and the branch instruction.

10. An apparatus according to claim 9, wherein the instruction authentication circuitry is configured to perform the cryptographic shuffle based on said key.

11. An apparatus according to claim 1, wherein the branch circuitry is configured to:
extract the instruction authentication value from the authenticatable instruction; and perform the authentication of the authenticatable branch instruction based on the extracted function authentication value.

12. An apparatus according to claim 11, wherein the branch circuitry is configured to:
extract the instruction authentication value by: performing a cryptographic deshuffle of the authenticatable branch instruction;
and extracting a block of bits, corresponding to the instruction authentication value, from the deshuffled authenticatable branch instruction.

13. An apparatus according to claim 11, wherein the branch circuitry is configured to:
identify an address associated with said function by extracting a plurality of address bits from the authenticatable branch instruction; and
execute said jump based on said plurality of address bits.

14. An apparatus according to claim 1, further comprising:
interface circuitry to receive a pointer comprising a plurality of address bits; and
pointer processing circuitry to:
extract said plurality of address bits from the pointer;
encrypt said plurality of address bits, to produce a plurality of encrypted address bits;
determine, based at least in part on the plurality of address bits, a pointer authentication value; and
combine the pointer authentication value with the plurality of encrypted address bits, to produce a signed encrypted pointer.

15. A method comprising:
receiving, as part of a program flow, a branch instruction, said branch instruction identifying a function;
determining, based at least in part on the function, an instruction authentication value;
combining the instruction authentication value with the branch instruction to produce an authenticatable branch instruction;
based on a function authentication value, authenticating the authenticatable branch instruction; and
responsive to a successful authentication of the authenticatable branch instruction, executing a jump in the program flow to said function.

16. A non-transitory computer-readable medium to store computer-readable code for fabrication of the apparatus of claim 1.

17. A computer program for controlling a host data processing apparatus to provide an instruction execution environment comprising:
instruction receiving logic to receive, as part of a program flow, a branch instruction, said branch instruction identifying a function;
instruction authentication logic to:
determine, based at least in part on the function, an instruction authentication value; and
combine the instruction authentication value with the branch instruction to produce an authenticatable branch instruction, and branch logic to:
based on a function authentication value, authenticate the authenticatable branch instruction; and
responsive to a successful authentication of the authenticatable branch instruction, execute a jump in the program flow to said function.
